(19) United States
(12) Patent Application Publication
(10) Pub. No.: US 2015/0113544 A1
(43) Pub. Date: Apr. 23, 2015

(54) METHOD FOR CONTROLLING PROCESS OF APPLICATION AND COMPUTER SYSTEM

(71) Applicant: Tencent Technology (Shenzhen) Company Limited, Shenzhen Guangdong (CN)

(72) Inventor: Xiao Yu, Shenzhen Guangdong (CN)

(73) Assignee: Tencent Technology (Shenzhen) Company Limited

(21) Appl. No.: 14/583,495

(22) Filed: Dec. 26, 2014

Related U.S. Application Data
(63) Continuation of application No. PCT/CN2013/090722, filed on Dec. 27, 2013.

(30) Foreign Application Priority Data
Mar. 25, 2013 (CN) 201310098004.3

(51) Int. Cl. G06F 9/54

(52) U.S. Cl. CPC G06F 9/54
USPC 719/320

(57) ABSTRACT

Controlling a process of an application in a computer system is described. A driving module in the computer system may control a process of a first application. The driving module may determine a memory space for the process of the first application, and inject instructions of a second application into the memory space. The driving module may trigger a first application module in the computer system to execute the process of the first application, which is injected with the instructions. The driving module may have a relatively high calling privilege and hence does not give rise to code injecting failures that may be faced by a low privilege application. Further, since the security of operations of the driving module may be determined by the driving module itself, the operation for injecting instructions may not be considered and intercepted as a potentially harmful operation.

This application is a continuation application of PCT international application PCT/CN2013/090722, filed on Dec. 27, 2013, which claims the priority of Chinese Patent Application No. 201310098004.3, entitled “METHOD FOR CONTROLLING PROCESS OF APPLICATION AND COMPUTER SYSTEM,” filed with the Chinese Patent Office on Mar. 25, 2013, both of which are incorporated herein by reference in their entirety.

### FIELD OF THE DISCLOSURE

The present disclosure relates to the field of computer technology, and particularly to controlling a process of an application in a computer system.

### BACKGROUND

Generally, in a computer system, applications may be divided into layers based on a level of privilege provided to each application. The level of privilege may determine how much access an application has to the functionalities available via the computer system. Typically, the higher the layer of an application, the lower the level of privilege. Thus, in a computer system, a driving module is at a bottom layer and multiple application modules are at an upper layer. A kernel layer is the operating system layer with highest level of privilege. An Application Programming Interface (API), which may be called by a kernel layer of the system on which the driving modules operate, is a bottom layer interface, and has a high privilege. An application module may execute the process of the corresponding application. Typically, each application executes in a corresponding memory space, which may be referred to as application memory space. The execution may be performed according to the codes, or instructions of the application in the corresponding memory space.

If a first application module wants to control a process of a second application which is executed by a second application module, the first application module may have to insert instructions, or code, into the instructions of the second application. The instructions of the second application may be stored in a memory space corresponding to the second application module. In this way, the instructions, including those inserted by the first application module, may be executed by the second application module as part of the second application process. Thus, the first application module may control the process of the second application. However, there are various barriers encountered during the implementation of such a code injection technique. For example, the privilege of the first application module may be too low, or the operation for injecting codes may be considered a dangerous, or potentially harmful, or an insecure, operation and thus may be intercepted, and aborted.

### SUMMARY

A method for controlling a process of an application and a computer system are described in the present disclosure. Various embodiments are described, which may effectively inject instructions into a process of an application and control the process of the application.

A method for controlling a process of the application may be performed in a computer system, which may include a driving module and multiple application modules. The method may include determining, by the driving module, a memory space for a process of a first application. The first application may be executing, or running in the computer system. The memory space may be allocated for the execution of the first application. The driving module may inject instructions of a second application into the memory space allocated for the process of the first application. The method may further involve triggering, by the driving module, a first application module of the multiple application modules to execute the injected instructions of the second application. The injected instructions may be executed in response to the process of the first application being executed.

A computer system, according to an embodiment may include a driving module and multiple application modules. The driving module may further include a memory determining unit, a code injecting unit, and a triggering unit. The memory determining unit may determine a memory space for a running process of a first application. The code injecting unit may inject instructions of a second application into the memory space for the process of the first application. The triggering unit may trigger a first application module of the multiple application modules. The injected instructions of the second application may execute in response to the execution of the process of the first application.

Thus, the process of the first application may be controlled. The driving module in the computer system may determine the memory space for the process of the first application, and inject the instructions of the second application into the memory space. The driving module may further trigger the first application module in the computer system to execute the process of the first application injected with the instructions. The driving module may have a relatively high calling privilege. Therefore, a code injecting failure that may arise due to a low privilege application attempting to perform such operations, may be avoided. Further, the driving module itself may determine the security of operations of the driving module. Hence, operation for injecting instructions by the driving module may not be considered as a dangerous operation and will not be intercepted. Therefore, with the method, system and other technical solutions, enable instructions to be effectively injected into the process of the application, and thereby control the process of the application.

### BRIEF DESCRIPTION OF THE DRAWINGS

In order to more clearly illustrate the technical solution in the embodiments of the present disclosure or in the prior art, in the following, accompanying drawings required in the description of the embodiments or the prior art will be introduced simply. The accompanying drawings in the following description are just some embodiments of the present disclosure. For those skilled in the art, other accompanying drawings can also be obtained according to these accompany drawings without any creative work.

FIG. 1 is a flow chart of an example method for controlling a process of an application according to an embodiment of the present disclosure;

FIG. 2 is a flow chart of an example method for controlling a process of an application according to an embodiment of the present disclosure;

FIG. 3 is a schematic structural diagram of an example system according to an embodiment of the present disclosure;

FIG. 4 is a schematic structural diagram of another example system according to an embodiment of the present disclosure; and

FIG. 5 is a schematic structural diagram of an example device that controls the process of an application according to an embodiment of the present disclosure.

### DETAILED DESCRIPTION

In the following, the technical solution presented by the present disclosure will be described using example embodiments in conjunction with the accompanying drawings. The described embodiments are just a few of the various possible embodiments of the technical solution, and are not all embodiments possible. All other embodiments obtained by those skilled in the art based on the embodiments of the present disclosure without any creative work will fall within the scope of protection of the present disclosure. The partitioning of examples in function blocks, modules, or units shown in the drawings is not to be construed as indicating that these function blocks, modules or units are necessarily implemented as physically separate units.

In a computer system, a software application that may be executed on the computer system may also be referred to simply as an application. An application is called a “program” before being it is executed, or run. Upon execution, the application may be called into, or assigned, or allocated a memory space. The memory space may be a range of addresses in a memory of the computer system that may be allocated, or assigned for execution of the application. The application is generally called a “process” after being called for execution and having been assigned system resources by the computer system. Thus, a ‘process’ of an application refers to an active application.

A method for controlling a process of an application is provided according to embodiments of the disclosure. The described method may be applied in a computer system. An example computer system may include a driving module, a storage module and multiple application modules. The driving module may be part of the operating system of the computer system. For example, the driving module may be a driver, such as a printer driver, or display driver, corresponding to one or more components of the computer system. Alternatively or in addition, the driving module may be File System Driver (FSD), such as a New Technology File System (NTFS) driver; an intermediate driver, or a device driver. An intermediate driver may be part of a Network Driver Interface Specification (NDIS) of an operating system, such as Microsoft Windows. The intermediate driver may facilitate communication between lower-level drivers that manage hardware from upper-level drivers, such as network transports. Alternatively or in addition, the intermediate driver may be used to translate between different network media, and/or balance packet transmission across more than one Network Interface Cards (NIC). For example, a load balancing driver exposes one virtual adapter to overlying transport protocols and distributes send packets across more than one MC. The intermediate driver, such as a virtual disk or mirror driver may include a function driver, a filter driver, a software bus driver, and other types of drivers.

For example, a high level driver may include file system drivers, such as File Allocation Table (FAT), New Technology File System (NTFS), Compact Disc File System (CDFS), and/or any other high level driver. For the high level driver to operate, the high level driver may communicate with a low level driver. The low level driver, for example, may be a device driver, such as a Plug-and-Play (PnP) hardware bus driver, a legacy device driver, and/or any other device driver. However, the high level driver may not be able to communicate with the low level driver directly. An intermediate driver, such as the filter driver, may enable communication between the high level driver and the low level driver. For example, if the low level driver is a legacy device driver, the intermediate driver may include a legacy virtual disk or a mirror driver, that may enable communication with the legacy driver. Alternatively or in addition, if the low level driver is a PnP hardware bus driver, the intermediate driver may include PnP filter drivers, PnP function drivers, such as Windows Driver Model (WDM) class/miniclass driver pair. The intermediate driver may also include a software bus driver or a WDM software bus driver to enable the communication between the high level and the low level drivers.

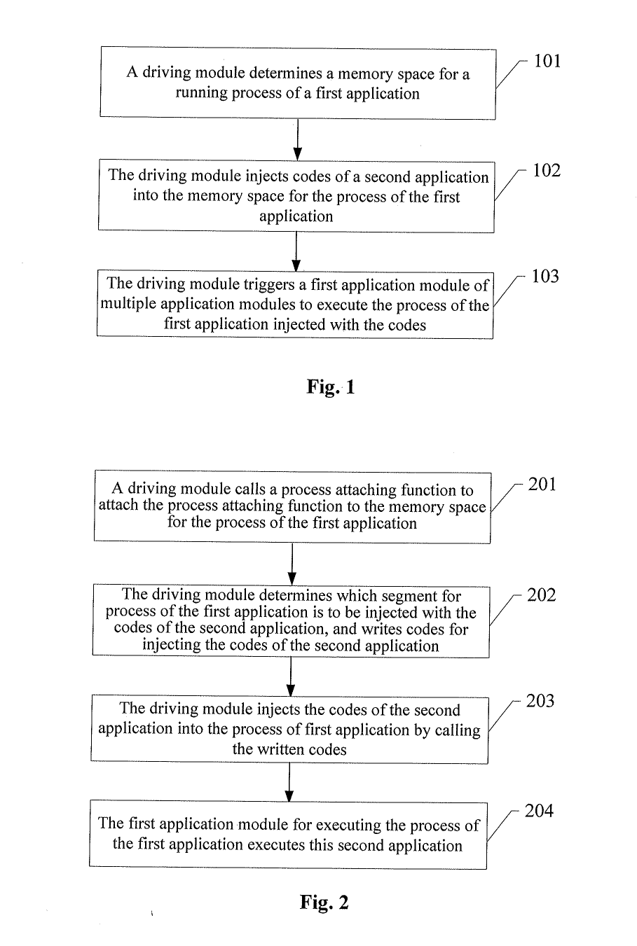

In the examples described, the driving module is an intermediate driver, however it may be any other type of driving module. Each application module may execute the process of a corresponding application. The execution of the process may be performed according to codes, or instructions, of the application module. The instructions may be in a memory space corresponding to the application module. The method may be performed by the computer system while the process of the application is running, or being executed. A flow for the example method is shown in FIG. 1, which includes at least the steps 101-103.

In Step 101, the driving module in the computer system may determine a memory space for a process of a first application that is running. Each application module may execute codes of an application in the memory space of the application. If a process of an application, for example a first application, is to be controlled by a process of another application, such as a second application, the driving module may determine the memory space for the process of the first application. The ‘process’ of an application refers to an active application. That is, the driving module has put codes of the application in the corresponding memory space, so that the process occupies some system resources. An application is called a “program” before being called into a memory space, and is called “process” after being called and having assigned system resources. A process may include many threads for execution. The memory space corresponding to the application is a range of memory addresses in the storage module of the computer system. The range of memory addresses may be reserved for storing the codes of the application in the storage module. The addresses may be reserved such that each application may correspond to a segment of space in the storage module. Thus, in step 101, the driving module may determine the range of memory addresses reserved for execution of the process of the first application module.

Further, the driving module may determine a relationship between the functions included in the process of the first application. For example, the driving module may call a process attaching function, such as KeAttachProcess function, to access the memory space for the process of the first application. The driving module may identify process contexts corresponding to the process of this first application based on information obtained from the process attaching function, such as the relationship between the functions included in the process of the first application. By analyzing the obtained information, the driving module may determine which segment for the process of the first application may be injected with the codes of a second application program. For example, the driving module may call a process attaching function, such as KeAttachProcess function, to access the memory space for the process of the first application. The driving module may identify process contexts corresponding to the process of this first application based on information obtained from the process attaching function, such as the relationship between the functions included in the process of the first application. Then, the driving module may inject the codes of the second application into the memory space for the process of the first application. Finally, the driving module may call a process detaching function, such as KeDetachProcess function, so as to switch out from, or relinquish access to the memory space of the process of the first application.

In Step 102, the driving module may inject the codes of the second application into the memory space for the process of the first application. For example, the driving module may assign to the codes of the second application a memory subspace in the memory space for the process of the first application which is determined in step 101. Thus, the memory subspace may be a part of the space of the storage module corresponding to this first application. The codes of the second application may be stored in the assigned memory subspace. Alternatively, the memory subspace may be included in the memory space for the process of the first application. In this way, the first application module executing the process of the first application may execute the codes in the memory subspace. After this step, the driving module may call a process detaching function, such as KeDetachProcess function, so as to switch out from, or relinquish access to the memory space of the process of the first application.

The codes injected into the memory subspace may be native codes, such as machine-readable instructions, for example assembly instructions or binary instructions, and not high level programming language instructions. The functions in the native codes may be directly called based on specific memory address of the functions instead of by the API interface.

In Step 103, the driving module may trigger the first application module from among the multiple application modules. The first application module may be triggered to execute the injected codes of the second application in response to the process of the first application being executed. Alternatively or in addition, the first application module may be triggered to execute the first application in which the code of the second application is injected.

When the first application module is executing the process of the first application, the driving module is adapted to trigger the first application module to execute the codes injected in step 102. For example, the driving module may insert an asynchronous procedure call (APC) function or a hook function into a certain active thread of the first application. The process of each application may include multiple executing flows, such as active threads. In this way, when executing the active thread, the first application module may call the codes in the memory subspace according to the injected APC or hook function, and may execute the codes in response to the APC or hook function.

For example, a process of a certain application may include active threads A, B and C. The driving module may insert the APC function or the hook function into the active thread B. In this case, the first application module may perform the injected codes of the second application while executing the active thread B.

It should be noted that the first application and the second application discussed may not represent a sequential relation, and the terms ‘first’ and ‘second’ are used simply for purpose of identifying the different applications.

Thus, to control the process of the first application, the driving module in the computer system may determine the memory space for the process of the first application. The driving module may inject the codes of the second application into this memory space. The driving module may further trigger the first application module in the computer system to execute the process of the first application injected with the codes. Since the driving module has a relatively high calling privilege, a code injection failure, which may be caused by a low privilege application performing code injection, may be avoided. Since the driving module itself determines the security of operations of the driving module, the operation for injecting codes may not be considered as a dangerous operation and therefore, may not be intercepted. Thus, the method according to the embodiment of the present disclosure, may effectively inject external code into the process of an application, thereby controlling the process of the application.

In an example embodiment, a user may want to achieve certain functions on a computer. However, the computer may not start and perform these functions without a relatively high privilege due to, for example, User Account Control (UAC). The desired functions may be achieved by the method according to the technical solutions of the present disclosure. In another case, the technical solutions described by the present disclosure, may enable the user to achieve some additional functions in a certain application. For example, the user may be able to achieve, in a browser, a function for protecting a user account for a website, or for reading a file stored on the computer, and other such functions.

The user may preset the program of the expected functions, (such as the codes of the second application above), in the driving module of the computer. In this case, the driving module may perform the functions during executing the process of the first application process by controlling the process of the first application. The first application may be a service program, which is being executed by the application module in a computer. A flow chart of an exemplary method performed by the driving module is shown in FIG. 2.

In Step 201, the driving module of the computer may call a process attaching function, such as a KeAttachProcess function in a Microsoft Windows based computer system. The process attaching function may allow the driving module to access the memory space for the process of the first application, so as to know the process context corresponding to the process of the first application.

In Step 202, the driving module may determine which segment for the process of the first application is to be injected with the codes of the second application, based on the process context of the first application. The driving module may then write codes for injecting the codes, such as those of a second application, in the first application.

For example, the driving module may first obtain native codes of the second application. The native codes may include the memory address of each function in the native codes. The driving module may further map the obtained data to a memory subspace in the memory space for the process of the first application. The mapping may include, for example, assigning a memory subspace to the native code of the second application, and storing the native code of the second application into the assigned memory subspace, where the assigned memory subspace can be recognized by the first application. Further, the driving module separates the process of the first application to insert the codes of the second application. For example, separating the process of the first application may include calling a process detaching function, such as KeDetachProcess function. The process detaching function may switch out from, or relinquish access to the memory space of the process of the first application. Finally, the driving module may create an event object for the operation of injecting the codes of the second application. The driving module may also create a function call object for triggering the execution of the injected codes of the second application.

In Step 203, the driving module may inject the codes of the second application into a corresponding process of the first application by calling the written codes.

In Step 204, the first application module for executing the process of the first application may execute the second application to achieve the function expected by the user.

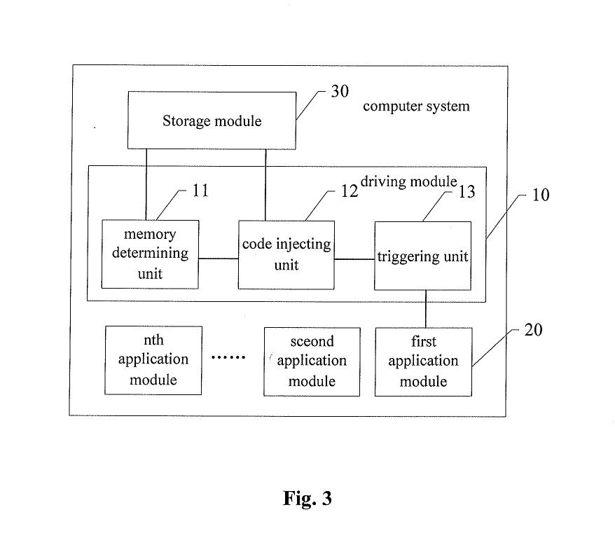

FIG. 3 shows the schematic structural diagram of an example computer system, which may include circuitry, such as a processor and a memory. The circuitry may operate a driving module 10, a storage module 30 and multiple application modules (n application modules are shown in the FIG. 3). The driving module 10 may include a memory determining unit 11, a code injecting unit 12 and a triggering unit 13.

The memory determining unit 11 may determine a memory space for a process of a first application that is running. For example, the memory determining unit 11 may call a process attaching function to look up the memory space.

The code injecting unit 12 may inject codes, such as those of a second application into the memory space, which is determined by the memory determining unit 11, for the process of the first application.

The memory space may store, for example, the codes of the first application. The memory space may be part of the storage module 30 of the computer system.

The triggering unit 13 may trigger a first application module of the multiple application modules to execute the process of the first application with the codes injected by the code injecting unit 12. For example, the triggering unit 13 may insert an asynchronous procedure call function or a hook function into an active thread of the first application.

Each application module may execute the process of the corresponding application according to the codes in a memory space allocated to the application. The first application module 20 may execute, in response to the triggering by the triggering unit 13, the process of the first application injected with the codes. If the triggering unit 13 inserts the APC function or the hook function into the active thread, the first application module 20 may execute the process of the injected code, such as that of the second application, while executing the active thread.

The driving module 10 of the computer system, according to an embodiment of the present disclosure, may control the process of the first application. The memory determining unit 11 may determine the memory space allocated for the process of the first application. The code injecting unit 12 may inject the codes, such as those of the second application, into the memory space. The triggering unit 13 may trigger the first application module 20 in the computer system to execute the process of the first application injected with the codes. The driving module may have a relatively high calling privilege. Therefore, code injecting failures, caused by low privilege applications, may be avoided. Further, the security of the driving module operation may be determined by the driving module itself. Hence, the operation for injecting codes may not be considered as a dangerous operation and may not be intercepted. Thus, the computer system may effectively inject codes into the process of an application, such as the first application, to control for the process of the application.

Referring to FIG. 4, in an embodiment, the code injecting unit 12 of the driving module in the computer system may further include an assigning unit 120 and an injecting unit 121.

The assigning unit 120 may assign a memory subspace, in the memory space for the process of the first application, to the codes of the second application.

The injecting unit 121 may store the codes of the second application in the assigned memory subspace.

In an embodiment, after the memory determining unit 11 determines the memory space for the process of the first application, the assigning unit 120 of the code injecting unit 12 may a memory subspace in this memory space. The injecting unit 121 may store the codes of the second application in the memory subspace assigned by the assigning unit 120, thereby achieving the code injection. Further, the triggering unit 13 may the first application module 20 to execute the process of the second application which is injected into the memory subspace by the injecting unit 121.

In another example, the method for controlling a process of an application according to the embodiments of the present disclosure may be performed by a terminal. The terminal may be a smart phone, a panel computer, an ebook reader, a Moving Picture Experts Group Audio Layer III (MP3) player, a Moving Picture Experts Group Audio Layer IV (MP4) player, a laptop portable computer, a desktop computer and so on.

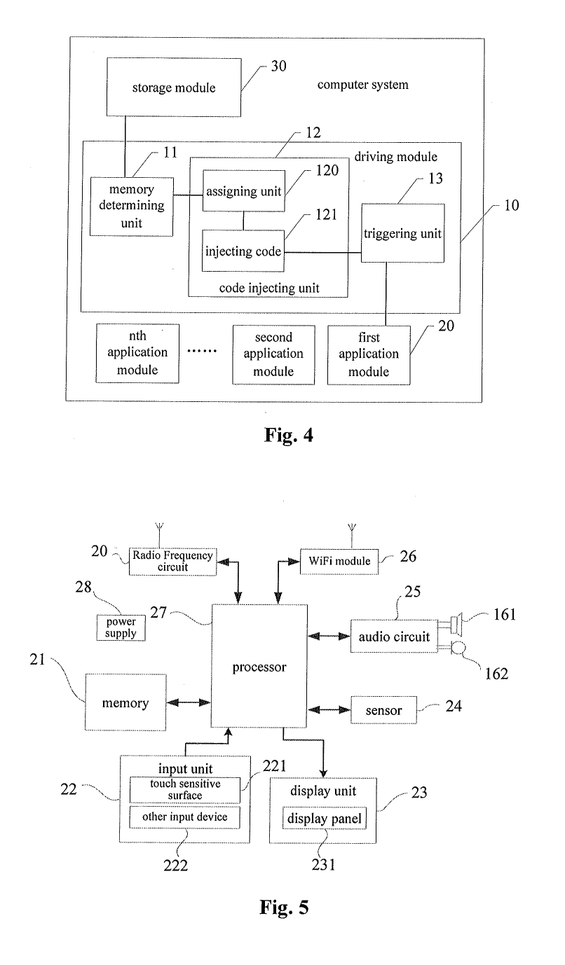

Reference is made to FIG. 5 which shows a schematic structural diagram of an example terminal.

The terminal may include circuitry such as a Radio Frequency (RF) circuit 20, a memory 21 including one or more computer readable storage mediums, an input unit 22, a display unit 23, a sensor 24, an audio circuit 25, a wireless fidelity (WiFi) module 26, a processor 27 including one or more processing cores, a power supply 28 and so on. Those skilled in the art can understand that the terminal is not limited to a structure of the terminal shown in FIG. 5, and may include more components or less components than the illustrated structure, a combination of the components, or a different arrangement of the components.

The RF circuit 20 may be adapted to receive and send information, or receive or send a signal in a calling procedure. For example, the RF circuit 20 may receive downlink information from a base station, and may transmit the information to one or more processors 27 to process. In addition, the RF circuit 20 may send uplink data to the base station. The RF circuit 20 may include at least an antenna, at least one amplifier, a tuner, one or more oscillators, a Subscriber Identity Module (SIM) card, a transceiver, a coupler, a Low Noise Amplifier (LNA), a duplexer and so on. Furthermore, the RF circuit 20 may also communicate with a network or other devices via a wireless communication. The wireless communication may be operated in any communication standard or protocol, which includes but is not limited to a Global System of Mobile communication (GSM), a General Packet Radio Service (GPRS), a Code Division Multiple Access (CDMA), a Wideband Code Division Multiple Access (WCDMA), a Long Term Evolution (LTE), an e-mail, a Short Messaging Service (SMS) and so on.

The memory 21 may store software programs or modules executed by a processor. As used herein, execution of a module by a processor can also refer to logic based processing by the module that is initiated directly or indirectly by a processor to complete a process or obtain a result. The processor 27 may perform various functions, such as application and data processing, by running the software programs or modules stored in the memory 21. The memory 21 may include a program memory area and a data memory area. The program memory area may store an operating system, an application required by at least one function (such as a sound playing function, an image playing function) and so on. The data memory area may store data (such as audio data, a phone book) created according to terminal utilization, and so on. Furthermore, the memory 21 may be a high speed random access memory, and may also be a nonvolatile memory such as at least one magnetic disk memory device, a flash memory device or other volatile solid state memory device. The memory 21 may also include a memory controller for providing, to the processor 27 and the input unit 22, access to the memory 21.

The input unit 22 may receive digital information or character information that is input. The input unit 22 may generate a signal input from an input device such as a keyboard, a mouse, a joystick or a trackball, which relates to the user settings and the function control. For example, in an embodiment, the input unit 22 may include a touch-sensitive surface 221 and other input devices 222. The touch-sensitive surface 221, also referred to as a touch screen or a touch panel, may collect touch operations performed by a user thereon or in the vicinity thereof. Such operations may be made by the user using any suitable object or accessory (such as a finger and a touch pen) on the touch-sensitive surface 221 or in the vicinity of the touch-sensitive surface 221. The touch-sensitive surface 221 may drive a corresponding connection device according to a program set in advance. The touch-sensitive surface 221 may include a touch detection device and a touch controller. The touch detection device may detect a touch position of the user and a corresponding signal caused by the touch operation, and may send the signal to the touch controller. The touch controller may receive the touch information from the touch detection device, convert the information into coordinates of the contact point, and send the coordinates of the contact point to the processor 27. In response, the touch detection device may receive a command to be performed, sent from the processor 27. Furthermore, the touch-sensitive surface 221 may be realized in multiple ways such as in resistive type, in capacitive type, in infrared type and in surface acoustic wave type. In addition to the touch-sensitive surface 221, the input unit 22 may also include other input devices 222. The other input devices 222 may include but are not limited to one or more of a physical keyboard, a function key (such as a volume control button, a switch button), a trackball, a mouse, a joystick and so on.

The display unit 23 may display information input by the user, information provided to the user and various graphic user interfaces of the terminal. The graphic user interfaces may include a graphic, a text, an icon, a video and any combination thereof. The display unit 23 may include a display panel 231. The display panel 231 may be a Liquid Crystal Display (LCD) or an Organic Light-Emitting Diode (OLED) display. Furthermore, the touch-sensitive surface 221 may cover the display panel 231. When the touch-sensitive surface 221 detects a touch operation thereon or in the vicinity thereof, the touch-sensitive surface 221 may send the detected touch operation to the processor 27 to determine a type of the touch event. The processor 27, in response, may provide a corresponding visual output on the display panel 231 according to the type of the touch event. Although the touch-sensitive surface 221 and the display panel 231 are shown as two separate components to realize the input function and the output function respectively in FIG. 5, the touch-sensitive surface 221 and the display panel 231 may be integrated together to realize the input and output functions, in some embodiments.

The terminal may further include at least one sensor 24 such as a light sensor, a motion sensor and other sensors. The light sensor may include an ambient light sensor and a proximity sensor. The ambient light sensor may adjust a brightness of the display panel 231 according to ambient light. The proximity sensor may turn off the display panel 231 and/or a backlight when the terminal is brought close to the user, such as to the user's ear. As one of the motion sensors, a gravity acceleration sensor may detect an acceleration value in each direction (generally, in three axial directions), and detect a value and direction of the gravity in a stationary state. The gravity acceleration sensor may be used by an application (such as for orientation change, related games, or magnetometer attitude calibration) for identifying the altitude of a cell phone, a function related to vibration identification (such as a pedometer, or a knock) and so on. The terminal may also be equipped with other sensors such as a gyroscope, a barometer, a hygrometer, a thermometer, an infrared sensor and other such sensors.

An audio interface between the user and the terminal may be provided by the audio circuit 25, a speaker 251 and a microphone 252. The audio circuit 25 may convert the received audio data into an electrical signal and transmit the electrical signal to the speaker 251. The speaker 251 may convert the electrical signal into a sound signal to output. On the other hand, the microphone 252 may the collected sound signal into an electrical signal and send the electrical signal to the audio circuit 25. The audio circuit 25 may convert the received electrical signal into audio data and output the audio data to the processor 27 to process. The processed audio data may then be sent to, for example, another terminal via the RF circuit 20 or output to the memory 21 to further process. The audio circuit 25 may also include an earphone jack for providing a communication between a peripheral headphone and the terminal.

WiFi represents a short range wireless transmission technology. The terminal may assist the user to send and receive e-mails, browse a webpage and access a streaming media and so on via the WiFi module 26. The WiFi module 26 may provide a wireless broadband internet access to the user. Although the WiFi module 26 is illustrated in FIG. 5, the WiFi module 26 may be omitted from other example terminals, without changing the scope or essence of the present disclosure.

The processor 27, as a control center of the terminal, may connect to each part of the terminal using various interfaces and wires. The processor may perform various functions of the terminal. For example, the processor 27 may process data by running or executing the software program and/or the software module stored in the memory 21 and calling data stored in the memory 21. The processor 27 may monitor and/or control operations the whole terminal. The processor 27 may include one or more processing cores. Preferably, an application processor and a modem processor can be integrated into the processor 27. In the processor 27, the application processor may process the operating system, user interfaces, applications and so on, and the modem processor may process wireless communication. It can be understood that the modem processor described above may not be integrated into the processor 27.

The terminal may further include the power supply 28 (e.g. a battery) for supplying power to each component. The power source may be logically connected to the processor 27 via a power supply management system, thus achieving functions such as charge management, discharge management, power consumption management by the power supply management system. The power supply 28 may further include any components, such as one or more DC power supplies or AC power supplies, a recharge system, a power supply fault detection system, a power supply converter or inverter, or a power supply state indicator.

Although not illustrated, the terminal may also include a camera, a Bluetooth module and so on. The processor 27 in the terminal may store, according to the following instructions, the codes of one or more application in the memory 21, and run the application stored in the memory 21 to realize various functions. The instructions may include instructions to perform at least the following steps. The instructions may be processed for determining a memory space for a running process of a first application, which may be achieved by calling a process attaching function. Further, instructions may be provided for injecting codes of a second application into the memory space for the process of the first application. A memory subspace in the memory space for the process of the first application may be assigned, or allocated where , and the codes of the second application may be stored in the assigned memory subspace. A first application module of multiple application modules may be triggered to execute the process of the first application injected with the codes. An asynchronous procedure call function or a hook function may be inserted into an active thread of the first application for execution of the injected codes.

It should be understood by those skilled in the art that all or a part of steps in various methods in the embodiments described above can be implemented by instructing related hardware using a program, the program can be stored in a computer readable storage medium, the storage medium may include a Read-Only Memory (ROM), a Random Access Memory (RAM), a magnetic disk, an optical disk or the like.

Example embodiments for controlling a process of an application in a system are described in the present disclosure. The technical solutions provided by the present disclosure have been described by specific examples, and the above description of the embodiments is just used to assist with understanding the solutions and the core concepts of the present disclosure. Those skilled in the art, may change the embodiments and the application scope according to the concept of the present disclosure, and such modifications would be within the scope of the present disclosure. Therefore, it should be understood that contents in the specification should not be deemed as limitations to the present disclosure.

1. A method for controlling a process of an application by a computer system comprising a driving module and a plurality of application modules, the method comprising:
determining, by the driving module, a memory space allocated for running a process of a first application;
injecting, by the driving module, instructions of a second application into the memory space of the process of the first application, wherein the instructions of the second application are injected into a memory subspace assigned for injecting instructions of the second application; and
triggering, by the driving module, execution of a first application module of the plurality of application modules, wherein the injected instructions of the second application are executed in response to the process of the first application being executed.

2. The method according to claim 1, wherein the determining the memory space for the process of the first application comprises:
calling a process attaching function by the driving module.

3. The method according to claim 1, wherein the instructions of the second application are raw instructions.

4. The method according to claim 1, wherein injecting instructions of the second application into the memory space allocated for the process of the first application comprises:
assigning the memory subspace in the memory space for the process of the first application,; and
storing the instructions of the second application in the assigned memory subspace.

5. The method according to claim 1, wherein the process of the first application comprises a plurality of active threads; and
the first application module is triggered by inserting, by the driving module, an asynchronous procedure call function or a hook function into an active thread of the first application.

6. The method according to claim 5, wherein in response to the active thread being executed, the first application module executes the injected instructions of the second application according to the asynchronous procedure call function or the hook function.

7. A computer system, comprising:
a processor;
a memory; and
one or more program units stored in the memory and to be executed by the processor, wherein the one or more program units comprises a driving module, a storage module and a plurality of application modules, and the driving module further comprises:
a memory determining unit adapted to determine a memory space allocated to a running process of a first application;
a code injecting unit adapted to inject instructions of a second application into an assigned memory subspace within the allocated memory space; and
a triggering unit adapted to trigger a first application module of the plurality of application modules to execute the injected instructions of the second application in response to the process of the first application being executed.

8. The computer system according to claim 7, wherein the memory determining unit is further adapted to call a process attaching function.

9. The computer system according to claim 7, wherein the instructions of the second application are in low-level form.

10. The computer system according to claim 7, wherein the code injecting unit comprises:
an assigning unit adapted to assign the memory subspace, within the memory space allocated to the process of the first application, the memory subspace assigned to the instructions of the second application; and
an injecting unit adapted to store the instructions of the second application in the assigned memory subspace.

11. The computer system according to claim 7, wherein the process of the first application comprises a plurality of active threads; and
the triggering unit is adapted to insert an asynchronous procedure call function or a hook function into one of the active threads of the first application.

12. The computer system according to claim 11, wherein in response to the active thread being executed, the first application module executes the injected instructions of the second application according to the asynchronous procedure call function or the hook function.

13. A non-transitory computer storage medium comprising computer executable instructions, wherein the computer executable instructions are adapted to control a process of an application in a computer system, and wherein the non-transitory computer storage medium comprises:
instructions to determine a memory space allocated for running a process of a first application;
instructions to inject instructions of a second application into an assigned memory subspace within the memory space allocated for the process of the first application; and
instructions to initiate execution of a first application module from among a plurality of application modules, wherein the injected instructions of the second application are executed in response to the process of the first application being executed.

14. The non-transitory computer storage medium according to claim 13, wherein the memory space allocated for the process of the first application is determined by instructions to call a process attaching function.

15. The non-transitory computer storage medium according to claim 13, wherein the instructions of the second application comprises low level instructions.

16. The non-transitory computer storage medium according to claim 13, wherein injecting the instructions of the second application comprises:
instructions to assign the memory subspace to the instructions of the second application, wherein the memory subspace is within the memory space for the process of the first application; and
instructions to store the instructions of the second application in the assigned memory subspace.

17. The non-transitory computer storage medium according to claim 13, wherein the process of the first application comprises a plurality of active threads, and the instructions to trigger the first application module of the plurality of application modules further comprises instructions to insert an asynchronous procedure call function or a hook function into one of the active threads of the first application.

18. The non-transitory computer storage medium according to claim 17, wherein in response to the active thread being executed, the first application module executes the injected instructions of the second application according to the asynchronous procedure call function or the hook function.
